(19) United States
(12) Patent Application Publication
(10) Pub. No.: US 2021/0001604 A1
(43) Pub. Date: Jan. 7, 2021

(54) FIRE-RETARDANT THERMALLY INSULATING LAMINATE

(71) Applicant: DDP SPECIALTY ELECTRONIC MATERIALS US, INC., Collegeville, PA (US)

(72) Inventors: Gregory T. Stewart, Midland, MI (US); Piyush Soni, Midland, MI (US); Mark W. Beach, Midland, MI (US); Kali Ananth Survadevara, Saginaw, MI (US)

(21) Appl. No.: 16/914,708

(22) Filed: Jun. 29, 2020

Related U.S. Application Data
(60) Provisional application No. 62/869,731, filed on Jul. 2, 2019.
(60) Provisional application No. 63/044,410, filed on Jun. 26, 2020.

(51) Int. Cl. B32B 15/08; E04B 1/94; B32B 27/28

(52) U.S. Cl. CPC B32B 15/08; E04B 1/941; B32B 27/283; B32B 2307/3065; E04B 2103/02; B32B 2255/26; E04B 2103/04; B32B 2375/00; B32B 2311/24; B32B 2419/00; B32B 2255/10; E04B 2103/06

(57) ABSTRACT

A fire-retardant laminate consists of a metallic foil having first and second surfaces, a primer layer having first and second surfaces, the first surface of the primer layer being attached to the first surface of the metallic foil and a fire-retardant coating applied on the second surface of the primer layer, wherein the fire-retardant coating comprises an aromatic isocyanate component, a polyol component and an intumescent component.

### FIELD OF THE INVENTION

The present disclosure relates to a fire-retardant laminate and a fire-resistant wood or other building product comprising the fire-retardant laminate.

### BACKGROUND

In some applications, there is a need for a low profile in-situ insulation for materials exposed to fires or extreme temperatures. An I-joist is one such structure requiring protection from heat and flame. Engineered wood I-Joists are quickly replacing lumber in new homes in order to accommodate trends in home design. In fire testing, these joists perform significantly worse than lumber as the binder quickly deteriorates and the joists lose mechanical integrity. ICC-ES AC14 testing criteria, which includes ASTM E119, is now being used to ensure engineered wood products perform like lumber in new constructions. ASTM E119 involves loading a floor made from at least one joist loaded to 50% of its full allowable stress design bending design load. The joist(s) are then subject to a temperature ramp in a chamber that is heated to almost 800° C., and if the floor supports the load and does not fail the specified deflection and deflection rate criteria, for 15 minutes and 31 seconds or longer, it is deemed as having equivalency to dimension lumber. An engineered wood I-joist without thermal protection will perform very poorly in this test, failing much quicker than dimension lumber. There are many ways of addressing this performance gap including finishing with drywall, which then limits the potential application of engineered I-joists to finished basements in new constructions. For unfinished basements, intumescent coatings, fire resistant polyisocyanurate foams, sprinkler systems, fiberglass reinforced magnesium oxide coatings, mineral wool insulation, and ceramic sheathing with intumescent paper are used.

There remains a need for a fire-retardant laminate which can be factory or field applied and is thinner than foams and wool insulation. Disclosed herein is a fire-retardant laminate system which requires only a small amount of fire-retardant coating that allows for the ability to factory or field apply the protection, ensuring uniform performance. This laminate also offers the benefit of being repaired easily in the field.

UK patent application 2053798A discloses a flame retardant laminate comprising a flammable substrate, a metal foil adhered to a face of the substrate, and a resin-saturated fibrous web adhered to the foil, the foil being between the fibrous web and the substrate. The web is formed predominantly of fire resistant fibers, such as glass, ceramic, phenolic, carbon, and asbestos. The resin saturating the web is selected from among vinyl compounds, acrylics, polyesters, polyamides, polyimides, melamines, phenolics, ureaformaldehyde resins, epoxies, modified cellulosics, and the like. The foil may be of any suitable metal, such as aluminum, having a thickness up to several mils. The substrate may be a construction material such as lumber, plywood, pressed board, chip board, hard board, or an insulative plastic foam.

U.S. Pat. No. 8,458,971 teaches fire-resistant wood products and formulations for fire-resistant coatings. In some embodiments, the disclosure includes a fire-resistant coating comprising an aromatic isocyanate (present in a quantity ranging from about 15% to about 39%), castor oil (present in a quantity ranging from about 37% to about 65%), and intumescent particles (present in a quantity ranging from about 1% to about 40%). Further aspects are directed towards materials such as wood products coated with fire-resistant coatings according to embodiments of the disclosure.

### SUMMARY OF THE INVENTION

A fire-retardant laminate consists of a metallic foil having first and second surfaces, a primer layer having first and second surfaces, the first surface of the primer layer being attached to the first surface of the metallic foil and a fire-retardant coating applied on the second surface of the primer layer, wherein the fire-retardant coating comprises an aromatic isocyanate component, a polyol component and an intumescent component.

### DETAILED DESCRIPTION OF THE INVENTION

As disclosed herein, “and/or” means “and, or as an alternative”. All ranges include endpoints unless otherwise indicated.

As disclosed herein, the terms “composition”, “formulation” or “mixture” refer to a physical blend of different components, which is obtained by simply mixing different components by physical means.

“Wood product” is used to refer to a product manufactured from logs such as lumber (e.g., boards, dimension lumber, solid sawn lumber, joists, headers, trusses, beams, timbers, moldings, laminated, finger jointed, or semi-finished lumber), composite wood products, or components of any of the aforementioned examples. The term “wood element” is used to refer to any type of wood product.

“Composite wood product” is used to refer to a range of derivative wood products which are manufactured by binding together the strands, particles, fibers, or veneers of wood, together with adhesives, to form composite materials. Examples of composite wood products include but are not limited to parallel strand lumber (PSL), oriented strand board (OSB), oriented strand lumber (OSL), laminated veneer lumber (LVL), laminated strand lumber (LSL), particleboard, medium density fiberboard (MDF) and hardboard.

“Intumescent particles” refer to materials that expand in volume and char when they are exposed to fire.

The word “coating” and “formulation” can be substituted with each other and they have the same meaning for the purpose of this invention.

The word “weatherability” is used to describe the ability of the material to withstand exterior exposure as would be necessary for factory application and is described in section A4.4.5 of the ICC-ES AC14: Acceptance Criteria for Prefabricated Wood I-Joists. Weatherability refers to a materials ability to retain fire performance after exposure to ultraviolet light and water and also soaked in water and then frozen as described in the AC14 test method or the methods used here for small scale testing.

Fire-Resistant Wood Product

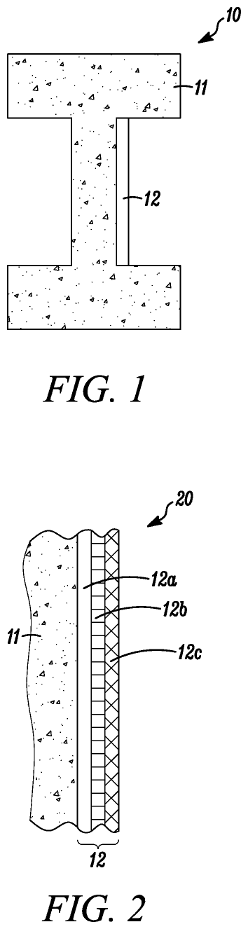

A fire-resistant wood product is shown generally at 10 in FIG. 1 and comprises a wood element 11 having one or more surfaces and a fire-retardant laminate 12 applied to at least a portion of the one or more surfaces of the wood element. In some embodiments, the entire surface of the wood element may be covered by the fire-retardant laminate. In other embodiments, the fire-retardant laminate covers from about 50% to 100% of the surface of the entire wood element. For convenience, the wood element 11 is shown as an I-beam structure but other structural forms are equally appropriate.

In some embodiments, a cellulose-based, gypsum, (bio)polymeric, or cementitious element may replace the wood element 11.

Fire-Retardant Laminate

A fire-retardant laminate 12 is shown generally at 20 in FIG. 2 and consists of a metallic foil 12a having first and second surfaces; a primer layer 12b having first and second surfaces, the first surface of the primer layer being attached to the first surface of the metallic foil and a fire-retardant coating 12c applied on the second surface of the primer layer. The second surface of metallic foil 12a contacts a surface of the wood element 11.

Preferably the fire-retardant laminate, when subjected to 3 cycles of water soak-freeze-thaw or 7 cycles of UV exposure and water spray testing as per standard ICC-ES AC14-October 2017, has a burn through time of at least 90% of that of an identical laminate not subjected to freeze-thaw soak and UV exposure and water spray.

Fire-Resistant Building Product

A fire-resistant building product comprises a wood, gypsum or cementitious element having one or more surfaces; and a fire-retardant laminate as described herein having first and second surfaces wherein the second surface of the metallic foil component of the fire-retardant laminate is applied to at least a portion of the one or more surfaces of the wood, gypsum or cementitious element. In some embodiments, the gypsum element may be cellulose based and the cementitious element (bio)polymeric based.

Foil

Preferably the metallic foil is aluminum although foil of other metals could be used. In some embodiments, the foil has a thickness of from 12.7 to 101.6 micrometers (0.0005 to 0.0040 inch). In some other embodiments, the foil has a thickness of from 17.78 to 38.1 micrometers (0.0007 to 0.0015 inch). The surface of the foil may also be treated by means such as corona or other plasma technologies to enhance the bondability with the primer layer. The foil functions as an impermeable substrate. As an alternative to metallic foil, a polymeric film could be used provided the film is impermeable to flammable wood off-gassing products during fire and the film is resistant to the high temperatures created during a fire. The film must also be capable of having good adhesion compatibility with the coating.

Preferably the bond of the primer layer to the foil is such that when tested for adhesive failure after exposure to fire, the failure is within the charred primer rather than at the interface of primer and foil.

Primer Layer

In preferred embodiments, the primer layer has an areal weight of from 1.0 to 2.0 gsm, more preferably from 1.1 to 1.3 gsm. A typical primer layer thickness is from about 1 to 10 micrometers thick. Suitable compositions for the primer include thermoset aromatic epoxy resins such as bisphenol A based epoxy resins and phenolic and cresol based novolac resins, styrenic-acrylic copolymers, styrenic-butadiene copolymers and acrylonitrile-based acrylic polymers. A preferred primer is a silicone-based primer such as Betaseal 16100A from DuPont, Wilmington, Del. Other silicone-based primer examples include Dowsil™ 1200 OS primer from Dow, Midland, Mi and SILQUEST*silanes from Momentive Performance Materials, Waterford, N.Y. In some embodiments, when a silicone-based primer is used, a preferred polyol is a polyester polyol such as an aromatic polyester polyol. The primer layer may be applied to the foil in situ at the assembly site or pre-applied using any suitable roll or knife coating technology.

Fire-Retardant Coating

The fire-retardant coating comprises an aromatic isocyanate component, a polyol component and an intumescent component.

The Aromatic Isocyanate Component

The aromatic isocyanate component of the fire-retardant coating may be present in a quantity ranging from about 10% to about 30% by weight of the coating, preferably about 15% to about 25% by weight of the coating.

The aromatic isocyanate may be a single aromatic isocyanate or mixtures of such compounds. Examples of the aromatic multifunctional isocyanates include toluene diisocyanate (TDI), monomeric methylene diphenyldiisocyanate (MDI), polymeric methylenediphenyldiisocyanate (pMDI), 1,5-naphthalenediisocyante, and prepolymers of the TDI or pMDI, which are typically made by reaction of the pMDI or TDI with less than stoichiometric amounts of multifunctional polyols.

The Polyol Component (Aromatic or Aliphatic)

The polyol component of the fire-retardant coating can be a synthetic or naturally derived polyol, polyether polyol, polyester polyol or a combination thereof.

The naturally derived polyol is naturally occurring, can be vegetable oil polyol or a polyol derived from vegetable oil. The naturally derived polyol has ester linkages and can be a castor oil or oxidized soybean oil, or a combination thereof.

Castor oil is a mixture of triglyceride compounds obtained from pressing castor seed. About 85 to about 95% of the side chains in the triglyceride compounds are ricinoleic acid and about 2 to 6% are oleic acid and about 1 to 5% are linoleic acid. Other side chains that are commonly present at levels of about 1% or less include linolenic acid, stearic acid, palmitic acid, and dihydroxystearic acid.

Polyether polyols can be the addition polymerization products and the graft products of ethylene oxide, propylene oxide, tetrahydrofuran, and butylene oxide, the condensation products of polyhydric alcohols, and any combinations thereof. Suitable examples of the polyether polyols include, but are not limited to, polypropylene glycol (PPG), polyethylene glycol (PEG), polybutylene glycol, polytetramethylene ether glycol (PTMEG), and any combinations thereof. In some embodiments, the polyether polyols are the combinations of PEG and at least one another polyether polyol selected from the above described addition polymerization and graft products, and the condensation products. In some embodiments, the polyether polyols are the combinations of PEG and at least one of PPG, polybutylene glycol, and PTMEG.

Polyether polyol can be an aromatic polyether polyol, for example, an aromatic resin-initiated propylene oxide-ethylene oxide polyol, such as IP 585 polyol available from the Dow Chemical Company.

The polyester polyols are the condensation products or their derivatives of diols, and dicarboxylic acids and their derivatives. Suitable examples of the diols include, but are not limited to, ethylene glycol, butylene glycol, diethylene glycol, triethylene glycol, polyalkylene glycols such as polyethylene glycol, 1,2-propanediol, 1,3-propanediol, 2-methyl-1,3-propandiol, 1,3-butanediol, 1,4-butanediol, 1,6-hexanediol, neopentyl glycol, 3-methyl-1,5-pentandiol, and any combinations thereof. In order to achieve a polyol functionality of greater than 2, triols and/or tetraols may also be used. Suitable examples of such triols include, but are not limited to, trimethylolpropane and glycerol. Suitable examples of such tetraols include, but are not limited to, erythritol and pentaerythritol. Dicarboxylic acids are selected from aromatic acids, aliphatic acids, and the combination thereof. Suitable examples of the aromatic acids include, but are not limited to, phthalic acid, isophthalic acid, and terephthalic acid; while suitable examples of the aliphatic acids include, but are not limited to, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, and 2,2-dimethyl succinic acid. Anhydrides of these acids can likewise be used. For the purposes of the present disclosure, the anhydrides are accordingly encompassed by the expression of term “acid”. In some embodiments, the aliphatic acids and aromatic acids are saturated, and are respectively adipic acid and isophthalic acid. Monocarboxylic acids, such as benzoic acid and hexane carboxylic acid, should be minimized or excluded.

Polyester polyols can also be prepared by addition polymerization of lactone with diols, triols and/or tetraols. Suitable examples of lactone include, but are not limited to, caprolactone, butyrolactone and valerolactone. Suitable examples of the diols include, but are not limited to, ethylene glycol, butylene glycol, diethylene glycol, triethylene glycol, polyalkylene glycols such as polyethylene glycol, 1,2-propanediol, 1,3-propanediol, 2-methyl 1,3-propandiol, 1,3-butanediol, 1,4-butanediol, 1,6-hexanediol, neopentyl glycol, 3-methyl 1,5-pentandiol and any combinations thereof. Suitable examples of triols include, but are not limited to, trimethylolpropane and glycerol. Suitable examples of tetraols include erythritol and pentaerythritol.

The polyol component may be present in a quantity ranging from about 20% to about 60% by weight of the coating. In a preferred embodiment, the polyol component may be present in a quantity ranging from about 30% to about 50%.

In one embodiment, the polyol component comprises castor oil and an aromatic polyol, such as IP585 (an aromatic polyether polyol from the Dow Chemical Company) or IP-9004 (an aromatic polyester polyol from the Dow Chemical Company). A combination of aromatic polyether polyol and aromatic polyester polyol can also be utilized. In another embodiment, the polyol component comprises of aliphatic polyether polyol and aromatic polyester polyol.

The amount of the castor oil in the polyol component is, by weight based on the weight of the polyol component, at least 50 wt. %, or at least 60 wt. %, or at least 70 wt. %. The amount of the castor oil in the polyol component is not to exceed, by weight based on the weight of the polyol component, 99 wt. %, or 97 wt. %, or 95 wt. %.

The amount of the aromatic polyol in the polyol component is, by weight based on the weight of the polyol component, at least 5 wt. %, or at least 10 wt. %, or at least 15 wt. %. The amount of the aromatic polyol in the polyol component is not to exceed, by weight based on the weight of the polyol component, 50 wt. %, or 40 wt. %, or 30 wt. %.

Intumescent Component

As described above, fire-resistant coatings according to embodiments of the disclosure also include an intumescent component.

The intumescent component may be present in a quantity ranging from about 1% to about 40% by weight of the total coating. In a preferred embodiment, the intumescent component is present in a quantity ranging from about 10% to about 35% by weight of the coating. The intumescent component may be intumescent particles.

Intumescent particles suitable for use with embodiments of the disclosure include expandable graphite, which is graphite that has been loaded with an acidic expansion agent (generally referred to as an “intercalant”) between the parallel planes of carbon that constitute the graphite structure. When the treated graphite is heated to a critical temperature, the intercalant decomposes into gaseous products and causes the graphite to undergo substantial volumetric expansion. Manufacturers of expandable graphite include GrafTech International Holding Incorporated (Parma, Ohio). Specific expandable graphite products from GrafTech include those known as Grafguard 160-50, Grafguard 220-50 and Grafguard 160-80. Other manufacturers of expandable graphite include HP Materials Solutions Incorporated (Woodland Hills, Calif.). There are multiple manufacturers of expandable graphite in China and these products are distributed within North America by companies that include Asbury Carbons (Sunbury, Pa.) and the Global Minerals Corporation (Bethesda, Md.). Further, other types of intumescent particles known to a person of ordinary skill in the art would be suitable for use with embodiments of the disclosure. Preferably, the intumescent and FR components are insoluble in water.

Additive Components

In addition to the aromatic isocyanate, the polyol component and the intumescent component, the fire-resistant coatings according to embodiments of the disclosure may include one or more additive components.

The additive component may be present in a quantity ranging from about 0.5% to about 30% by weight of the coating, preferably from about 10% to about 20% by weight of the coating.

Additives that may be incorporated into the fire-retardant coating formulation to achieve beneficial effects include but are not limited to surfactants, wetting agents, opacifying agents, UV stabilizers, anti-fungal agents, colorants, viscosifying agents, catalysts, preservatives, fillers, leveling agents, defoaming agents, diluents, hydrated compounds, halogenated compounds, moisture scavengers (for example molecular sieves, aldimines or p-toluenesulfonyl isocyanate), acids, bases, salts, borates, melamine and other additives that might promote the production, storage, processing, application, function, cost and/or appearance of this fire-retardant coating for wood products.

Additional flame-retardant (FR) additives may be added to the coating to enhance the flame-retardant properties of the coating. For example, a halogenated flame retardant may be added to reduce flame spread and smoke production when the coating is exposed to fire. Halogenated flame retardants prevent oxygen from reacting with combustible gasses that evolve from the heated substrate, and react with free radicals to slow free radical combustion processes. Examples of suitable halogenated flame-retardant compounds include chlorinated paraffin, decabromodiphenyloxide, available from the Albemarle Corporation under the trade name SAYTEX 102E, and ethylene bis-tetrabromophthalimide, also available from the Albemarle Corporation under the trade name SAYTEX BT-93. The halogenated flame-retardant compound is typically added to the coating in a quantity of 0-5% of the coating by weight, although greater amounts may also be used. Often, it is desirable to use the halogenated flame-retardant compound in combination with a synergist that increases the overall flame-retardant properties of the halogenated compound. Suitable synergists include zinc hydroxy stannate and antimony trioxide. Typically, these synergists are added to the coating in a quantity of 1 part per 2-3 parts halogenated flame retardant by weight, though more or less may also be used. In addition, other organophosphorus flame retardants, such as resorcinol bis(diphenylphosphate) (RDP) and bisphenol A bis(diphenylphosphate) (BPA-BDPP) can also be added to the coating to enhance the flame-retardant properties of the coating.

Examples of suitable phosphorus flame or fire-retardant materials include any one or any combination of more than one material selected from a group consisting of ammonium polyphosphate phase I, ammonium polyphosphate phase II, melamine formaldehyde resin modified ammonium polyphosphate, silane modified ammonium polyphosphate, melamine polyphosphate, bisphenol A bis(diphenyl phosphate), cresyldiphenyl phosphate, dimethylpropane phosphonate, polyphosphonates, metal phosphinate, phosphorus polyol, phenyl phospholane, polymeric diphenyl phosphate, resorcinol-bis-diphenylphosphate, triethyl phosphate, tricresyl phosphate, triphenyl phosphate, red phosphors, phosphate acid, ammonium phosphate. The amount of phosphorus material is selected so as to provide a phosphorus concentration of one wt. % or two wt. % or more, preferably three wt. % or more, more preferably four wt. % or more, five wt. % or more, six wt. % or more seven wt. % or more, eight wt. % or more, nine wt. % or more, 10 wt. % or more and at the same time is selected so as to provide a phosphorous concentration of 15 wt. % or less, 14 wt. % or less 13 wt. % or less, 12 wt. % or less, 11 wt. % or less or even 10 wt. % or less. Determination of wt. % phosphorus relative to total weight of intumescent coating is achieved by using X-ray fluorescence as described in ASTM D7247-10.

Other suitable FR additives include boehmite; aluminum hydroxide; magnesium hydroxide and antimony trioxide.

Preferably, the FR additives are insoluble in water.

Preparation of Coating

The components described above may be combined using a number of different techniques. In some embodiments, intumescent particles are dispersed in the polyol along with other additives to form a relatively stable suspension, which can be shipped and stored for a period of time until it is ready to be used. Such a mixture can be referred to in this disclosure as the “polyol component.” The aromatic isocyanate component (e.g., aromatic isocyanate or mixture of aromatic isocyanates) is generally stable and can be shipped and stored for prolonged periods of time as long as it is protected from water and other nucleophilic compounds. Such a mixture can be referred to in this disclosure as the “aromatic isocyanate component”. Prior to application, these two components may be mixed together at a ratio that is generally about 10 to about 30% aromatic isocyanate component and 70 to about 90% polyol component, preferably, with the polyol component containing castor oil. This formulating strategy results in a polyurethane matrix with a suitable level of elasticity for use as a fire-resistant coating. Further, in some embodiments, other advantages may be realized. For example, the prepolymers of TDI or pMDI can have beneficial effects on the elasticity of the polymer matrix and they can alter the surface tension of uncured liquid components so that the intumescent particles tend to remain more uniformly suspended when the polyol and isocyanate components are combined just prior to application.

Prior to application of the coating to the foil substrate, mixing of the reactive components, especially the polyol and the aromatic isocyanate compounds, should be performed. In one embodiment the intumescent particles can be suspended in polyol along with the other formulation additives to make a stable liquid suspension, which can later be combined with the aromatic isocyanate compounds. Accordingly, the two liquid components can be combined at the proper ratio and mixed by use of meter-mixing equipment, such as that commercially available from The Willamette Valley Company (Eugene, Oreg.) or Graco Incorporated (Minneapolis, Minn.) or ESCO (Edge Sweets Company). In some embodiments, three or more components (naturally derived polyol, aromatic polyol, intumescent, and aromatic isocyanates) can all be combined using powder/liquid mixing technology just prior to application. In some embodiments, the formulation has a limited “pot-life” and should be applied shortly after preparation. Thereafter, the formulation subsequently cures to form a protective coating that exhibits performance attributes as a fire-resistant coating for wood products.

In the absence of a catalyst, the complete formulation may be applied to the primer surface in less than about 30 minutes after preparation. It is possible to increase the mixed pot-life by decreasing the temperature of the formulation mixture or by use of diluents or stabilizers such as phosphoric acid. When catalysts are used in the formulation, the mixed pot-life can be less than about 30 minutes. Examples of catalysts include organometallic compounds, such as dibutyltin dilaurate, stannous octoate, dibutyltin mercaptide, lead octoate, potassium acetate/octoate, and ferric acetylacetonate; and tertiary amine catalysts, such as N, N-dimethylethanolamine, N, N-dimethylcyclohexylamine, 1,4-diazobicyclo[2.2.2]octane, 1-(bis(3-dimethylaminopropyl)amino-2-propanol, N, N-diethylpiperazine, DABCO TMR-7, and TMR-2.

Application of Coating

Coatings according to embodiments of this disclosure are applied to the primer layer. at an application level of about 0.246 to 14.79 kg/m² (0.05 to about 3.0 lb./ft²), more preferably about 0.493 to 9.86 kg/m² (0.1 to about 2.0 lb./ft²), most preferably about 0.493 to 2.46 kg/m² (0.1 to about 0.5 lb./ft²). The coating of the present invention may be applied in a variety of manners, such as spraying, knife over roll coating, or draw down using a Gardco Casting Knife Film Applicator.

Primer to Foil Adhesion

It is desirable that following exposure to fire, there remains good adhesion of intumescent char to the foil. Intumescent char on the foil provides an additional fire protective barrier to the wood or other substrate to which the fire-resistant laminate is attached.

### Examples

Examples prepared according to the current invention are indicated by numerical values. Control or Comparative Examples are indicated by letters. All parts and percentages are by weight unless otherwise specified.

Fire-Retardant Coating

The coating of Formulation 1 comprised the following materials:

| Material | Weight (g) |
|---|---|
| Papi 27 (PolyMDI Isocyanate) from Dow, Midland, MI | 18 |
| IP585 (aromatic polyether polyol) from Dow | 7 |
| Castor Oil from Sigma Aldrich, King of Prussia, PA | 35 |
| Resorcinol bis (diphenyl phosphate) grade | 13 |
| Fyrolflex RDP by ICL Industrial Products | |
| Expandable graphite grade 160-50-N from GrafTech | 27 |
| International Ltd, Parma, OH | |
| Surfactant DC-193 from Dow | 0.15 |
| Phosphoric Acid | 0.2 |
| DABCO TMR-2 (PU catalyst) from Evonik Industries | 0.22 |

Formulation 1 had an isocyanate index of 106.

The coating of Formulation 2 comprised the following materials:

| Material | Weight (g) |
|---|---|
| Papi 27 (PolyMDI Isocyanate) from Dow, Midland, Ml | 18 |
| Terate ® HT5350 (aromatic polyester polyol) from Invista, | 24 |
| Wichita, KS | |
| Voranol ® 220-056N polyol from Dow | 13 |
| Resorcinol bis (diphenyl phosphate) grade Fyrolflex RDP | 10 |
| Expandable graphite grade EG 300 from Qingdao Yanhai | 32 |
| Carbon Materials Co., Ltd. | |
| Surfactant DC-193 from Dow | 0.15 |
| Triethyl phosphate from Eastman Chemical Co., Kingsport, | 3 |
| TN. | |

Formulation 2 had an isocyanate index of 83.

Fire-Retardant Laminate Substrate

Several substrates were used:

(a) Clay coated glass fiber mat (CCGF) was Webtech® coated glass facers from Atlas Coating, Meridian, Miss.
(b) Fiberglass mat (FM) was PCN 1730 Glass Fiber Facer from Owens Corning, Toledo, Ohio.
(c) Aluminum foil glass mat (AFGM) was a 0.0015 inch thick foil with fiberglass mat from Lamtec Corporation, Mt. Bethel, Pa. The primer of styrene butadiene copolymer was applied by the vendor.
(d) Non-primed aluminum foil (Gordon) was a 0.0009 inch heavy-duty foodservice foil from Gordon Food Service.
(e) Aluminum foil (0.0009 inch thick) with styrene-acrylate polymer primer and two different epoxy primers (Epoxy 1 and Epoxy 2) was obtained from Hanover Foils, Ashland, Va. The primers were applied by the vendor.

The fire-retardant coating compositions (Formulae 1 and 2) were prepared by thoroughly mixing all components except the polyMDI isocyanate. The pMDI was then added to the mixture to give the final coating composition.

Cone calorimetry was used to assess the efficacy of the fire-retardant laminates. Examples were assessed as part of a structure comprising oriented strand board (OSB) and the laminate. The OSB, obtained from Louisiana Pacific Corporation, Nashville, Tenn., was 7/16 inch thick. Six inch×six inch test coupons were cut from the board. In Comparative Example Set A where there was no substrate, the fire-retardant coating was coated directly onto the OSB. For the various substrates, the coating was applied to the substrate at a specific application rate (coating amount) and a 6 inch by 6 inch square was cut out of the cured laminate. The fire resistant laminate specimen was placed onto a 6 inch×6 inch× 7/16 inch thick OSB square with the coating facing away from the OSB surface. Aluminum foil was then wrapped around the coated OSB, leaving a 4 inch by 4 inch square window free from aluminum foil centered in the middle of the sample so that the coating is visible.

The wrapped sample was placed into a 6 inch by 6 inch stainless specimen sample frame with a corresponding 4 inch by 4 inch opening so that only the coating is visible from the top of the frame. A thermocouple was placed on the backside of the OSB and approximately centered in the 6 inch by 6 inch square. A stainless steel backer frame with mineral wool was applied to the back of the OSB to hold the sample against the inside of the top portion of the frame. The two sides of the frame were affixed together to hold the sample tightly in place.

The aforementioned assembly was placed into a standard cone calorimeter instrument designed to run the ASTM E 1354-17 test method. The calorimeter was set to heat the specimen at 50 kW/m² heat flux and the surface of the sample was mounted 2 inches below the heating element. Thermocouple readings were recorded during the test. The time (T), in minutes, for the thermocouple reading to rise from 50° C. to 250° C. was recorded for all samples and is shown in Table 1.

TABLE 1

| | | | | | Ex. 1 | Ex. 2 |
|---|---|---|---|---|---|---|
| | | | | | Set E | Betaseal |
| | Comp. Ex. | Comp. Ex. | Comp. Ex. | Comp Ex. | (Primed | 16100A |
| | Set A | Set B | Set C | Set D | Hanover | Primed Foil |
| | (No | (CCGF | (FM | (AFGM | Foil | (Gordon |
| | Substrate) | Substrate) | Substrate) | Substrate) | Substrate) | Substrate) |
| Primer | No | No | Yes | No | Yes | Yes |
| Coating | Time (T) | Time (T) | Time (T) | Time (T) | Time (T) | Time (T) |
| Amount | | | | | | |
| (lb./ft²) | | | | | | |
| Formula 1 | Formula 1 | Formula 1 | Formula 1 | Formula 1 | Formula 1 | Formula 2 |
| none | 4.6 | | | | | |
| 0.15 | 14.8 | 14.0 | | 19.8 | 25.9 | 23.8 |
| 0.25 | 19.6 | 21.6 | 18.7 | 29.9 | 26.6 | 24.8 |
| 0.35 | 19.3 | 25.5 | | 29.9 | 28.1 | 23.3 |

Table 1 shows that a laminate comprising only an aluminum foil substrate, a primer layer and a fire-retardant coating surprisingly and unexpectedly offers better or comparable fire induced heat transfer insulation when compared to the heavier comparative examples comprising glass mat substrates. For example, a typical primered foil has an areal weight of about 65 gsm whereas a typical primered foil on glass has an areal weight ranging from 103 to 168 gsm. The inventive example is also significantly better than those comparative ones where there is no substrate.

The adhesion between foil and intumescent char was tested for both formulations 1 and 2 on several substrates and primers. The Betaseal primer was applied to non-primed Gordon foil by DuPont. The fire tests were carried out in accordance with ASTM E 1354-17 and assessment was made visually on the tested foil substrate. 101 mm×101 mm (4″×4″) samples were tested at a heat flux of 25 kW/m² in the cone calorimeter. After the samples were exposed to heat they were allowed to cool. When cool, the samples were turned upside down and flexed to 45° by hand and then straightened to flat. This flexing was repeated five times. The percentage of clean substrate was determined. The samples with good adhesion were deemed to be those showing less than 20% clean foil substrate. The findings are summarized in Table 2.

TABLE 2

| | | | Adhesion |
|---|---|---|---|
| Formulation | Primer | Foil Type | Rating |
| 1 | Styrene-acrylate | Hanover | Poor |
| 2 | Styrene-acrylate | Hanover | Poor |
| 1 | Styrene-acrylate | Lamtec | Poor |
| 2 | Styrene-acrylate | Lamtec | Poor |
| 1 | Epoxy 1 | Hanover | Poor |
| 2 | Epoxy 1 | Hanover | Poor |
| 1 | Epoxy 2 | Hanover | Poor |
| 2 | Epoxy 2 | Hanover | Poor |
| 1 | Betaseal 16100A | Gordon | Poor |
| 2 | Betaseal 16100A | Gordon | Good |

It was surprisingly found that formulation 2 applied to a Betaseal 16100A silicone primer coated aluminum foil gave much better char adhesion than the other examples evaluated. It is believed that replacing castor oil in formulation 1 by an aromatic polyester polyol such as HT5350 in conjunction with a silicone-based foil primer such as Betaseal 16100A delivers a synergistic benefit in foil to char adhesion.

What is claimed is:

1. A fire-retardant laminate, comprising a metallic foil having first and second surfaces, a primer layer having first and second surfaces, the first surface of the primer layer being attached to the first surface of the metallic foil and a fire-retardant coating applied on the second surface of the primer layer, wherein the fire-retardant coating comprises an aromatic isocyanate component, a polyol component and an intumescent component.

2. The fire-retardant laminate of claim 1, wherein the aromatic isocyanate component is present in a quantity ranging from about 10% to about 30% by weight of the coating.

3. The fire-retardant laminate of claim 1, wherein the polyol component is present in a quantity ranging from about 20% to about 60% by weight of the coating.

4. The fire-retardant laminate, of claim 1, wherein the intumescent component is present in a quantity ranging from about 1% to about 40% by weight of the total coating.

5. The fire-retardant laminate, of claim 1, wherein the polyol component is an aromatic polyol, an aliphatic polyol or a combination thereof.

6. The fire-retardant laminate of claim 5, wherein the polyol component is selected from the group consisting of naturally derived polyol, polyether polyol, polyester polyol, or a combination thereof.

7. The fire-retardant laminate of claim 5, wherein the polyol component is a naturally derived polyol selected from the group consisting of castor oil, oxidized soybean oil, or a combination thereof.

8. The fire-retardant laminate of claim 5, wherein the polyol component is an aromatic or aliphatic polyol selected from the group consisting of aromatic or aliphatic polyether polyol, aromatic or aliphatic polyester polyol, or a combination thereof.

9. The fire-retardant laminate of claim 5, wherein the polyol component comprises a combination of castor oil and an aromatic polyol.

10. The fire-retardant laminate of claim 1, wherein the metallic foil is an aluminum foil.

11. The fire-retardant laminate of claim 1, wherein the fire-retardant coating further comprises one or more additive components.

12. The fire-retardant laminate of claim 1, wherein the primer layer is a silicone primer.

13. The fire-retardant laminate of claim 5, wherein the laminate comprises a polyester polyol and a silicone primer.

14. The fire-retardant laminate of claim 11, wherein the additive components are selected from the group consisting of surfactants, wetting agents, opacifying agents, colorants, viscosifying agents, catalysts, preservatives, fillers, leveling agents, defoaming agents, diluents, hydrated compounds, halogenated compounds, acids, bases, salts, borates, melamine, halogenated flame retardant, moisture scavenger, and organophosphorus flame retardants.

15. The fire-retardant laminate of claim 1, wherein after either 3 cycles of water soak-freeze-thaw or 7 cycles of UV exposure and water spray testing, the laminate, when tested to standard ICC-ES AC14-October 2017, has a burn through time of at least 90% of that of an identical laminate not subjected to water soak-freeze-thaw or UV exposure and water spray.

16. A fire-resistant wood product comprising:
a wood element having one or more surfaces; and
a fire-retardant laminate of claim 1 wherein the second surface of the metallic foil component of the fire-retardant laminate is applied to at least a portion of the one or more surfaces of the wood element.

17. A fire-resistant building product comprising:
a gypsum, or cementitious element having one or more surfaces; and a fire-retardant laminate of claim 1 wherein the second surface of the metallic foil component of the fire-retardant laminate is applied to at least a portion of the one or more surfaces of the gypsum, or cementitious element.
